(19) United States
(12) Patent Application Publication
(10) Pub. No.: US 2008/0295134 A1
(43) Pub. Date: Nov. 27, 2008

(54) RECEIVER AND SEMICONDUCTOR INTEGRATED DEVICE

(75) Inventors: Noboru Taga, Kanagawa (JP); Takashi Seki, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/123,798

(22) Filed: May 20, 2008

(30) Foreign Application Priority Data
May 23, 2007 (JP) 2007-137030

(51) Int. Cl. G06F 13/10

(52) U.S. Cl. 725/56

(57) ABSTRACT

A receiver includes: first and second tuners configured to select respectively different broadcast channels; first and second AGC control circuits configured to generate first and second AGC control signals configured to respectively control gains of first and second AGC amplifiers based on output signals of the respective tuners; first and second predetermined voltage generating circuits configured to generate first and second predetermined voltages configured to respectively suppress AGC gains of the first and second AGC amplifiers; and a control section configured to control to selectively apply the first AGC control signal and the first predetermined voltage to the first AGC amplifier, and control to selectively apply the second AGC control signal and the second predetermined voltage to the second AGC amplifier.

### CROSS REFERENCE TO RELATED APPLICATION

This application is based upon and claims the benefit of priority from the prior Japanese Patent Application No. 2007-137030 filed on May 23, 2007; the entire contents of which are incorporated herein by reference.

### BACKGROUND OF THE INVENTION

1. Field of the Invention

The present invention relates to a receiver and a semiconductor integrated device configured to suppress spurious interference and noise occurrence in a case where a plurality of tuners are provided.

2. Description of the Related Art

Recently, under circumstances in which there are digital broadcasts and analog broadcasts in a mixed manner, receivers in which a plurality of tuners capable of receiving both the digital broadcasts and the analog broadcasts are mounted have been increasingly used. There are also receivers capable of receiving a plurality of channels in order to record a program on a different channel. Furthermore, some digital broadcast receivers monitor an emergency start signal superimposed on a broadcast wave to be transmitted and are activated in response to the emergency start signal.

In a conventional receiver, a broadcast channel having a desired frequency is selected by a tuner, and an output signal of the tuner is input to an automatic gain control (AGC) control circuit configured to perform gain control of an AGC amplifier.

The AGC control circuit generates an AGC control signal configured to control a gain of the AGC amplifier in the tuner in accordance with an amplitude of an input signal. The AGC amplifier performs an AGC operation such that the output signal of the tuner has a predetermined amplitude level by the AGC control signal.

An AGC control loop is thereby formed such that the output signal of the tuner has a predetermined amplitude level.

However, for example, in a receiver in which two tuners are mounted, not both of the tuners are used to receive broadcasts by a user in some cases. In a tuner side which is not used, the AGC control loop is cut off and the AGC control signal becomes unstable.

The unstable AGC control signal exceedingly increases the gain of the AGC amplifier in the tuner, to cause spurious interference and noise occurrence on other peripheral circuits.

On the other hand, Japanese Patent Laid-Open No. 2000-295053 discloses a related art of a TV tuner circuit which mounts a single tuner therein, but in which a reception frequency is divided into three frequency bands and three AGC amplifiers appropriate for the respective frequency bands are provided.

In the related art, an AGC control circuit is configured to output an AGC voltage to one of the AGC amplifiers based on an input signal, and output a predetermined voltage or a minimum voltage to the other two AGC amplifiers in order to bring the two AGC amplifiers into an operation stop state.

In the related art, the AGC control circuit applies one AGC voltage input, which is input to the AGC control circuit, to one of the AGC amplifiers having a selected frequency band and applies the voltage for bringing into the operation stop state (for example, 0 V) to the other AGC amplifiers.

That is, an object of the related art is to select one broadcast, and a plurality of broadcasts cannot be appropriately received at the same time. Specifically, the AGC control circuit is configured such that the AGC voltage input as one input signal is commonly input thereto. Thus, even if the AGC voltage input is output to the two AGC amplifiers as the AGC voltage, proper AGC control cannot be performed since the same AGC voltage is used.

As described above, the related art disclosed in Japanese Patent Laid-Open No. 2000-295053 cannot appropriately handle simultaneous reception of a plurality of broadcasts in consideration of AGC control functions.

### SUMMARY OF THE INVENTION

A receiver according to one aspect of the present invention includes: a first tuner configured to select a broadcast channel; a first AGC control circuit configured to generate a first AGC control signal configured to control a gain of a first AGC amplifier provided in the first tuner based on an output signal from the first tuner; a first predetermined voltage generating circuit configured to generate a first predetermined voltage configured to suppress an AGC gain of the first AGC amplifier; a second tuner configured to select a broadcast channel different from that of the first tuner; a second AGC control circuit configured to generate a second AGC control signal configured to control a gain of a second AGC amplifier provided in the second tuner based on an output signal from the second tuner; a second predetermined voltage generating circuit configured to generate a second predetermined voltage configured to suppress an AGC gain of the second AGC amplifier; and a control section configured to control to selectively apply the first AGC control signal and the first predetermined voltage to the first AGC amplifier, and configured to control to selectively apply the second AGC control signal and the second predetermined voltage to the second AGC amplifier.

A semiconductor integrated device according to one aspect of the present invention includes: a first AGC control circuit configured to generate a first AGC control signal configured to control a gain of a first AGC amplifier provided in a first tuner configured to select a broadcast channel based on a first tuner output signal from the first tuner; a first predetermined voltage generating circuit configured to generate a first predetermined voltage configured to suppress an AGC gain of the first AGC amplifier; a second AGC control circuit configured to generate a second AGC control signal configured to control a gain of a second AGC amplifier provided in a second tuner configured to select a broadcast channel different from that of the first tuner based on a second tuner output signal from the second tuner; a second predetermined voltage generating circuit configured to generate a second predetermined voltage configured to suppress an AGC gain of the second AGC amplifier; and a control section configured to control to selectively apply the first AGC control signal and the first predetermined voltage to the first AGC amplifier, and configured to control to selectively apply the second AGC control signal and the second predetermined voltage to the second AGC amplifier, the first AGC control circuit, the first predetermined voltage generating circuit, the second AGC control circuit, the second predetermined voltage generating circuit and the control section being formed on a semiconductor integrated circuit.

### BRIEF DESCRIPTION OF THE DRAWINGS

FIG. 1 is a block diagram illustrating a configuration of a receiver according to a first embodiment of the present invention;

FIG. 2 is a flowchart illustrating an operation example according to the first embodiment;

FIG. 3 is a block diagram illustrating a configuration of a receiver according to a second embodiment of the present invention;

FIG. 4 is a flowchart illustrating an operation example according to the second embodiment;

FIG. 5 is a timing diagram explaining operations in a sleep operation mode according to the second embodiment; and

FIG. 6 is a flowchart illustrating one part of process contents according to a modified example.

### DETAILED DESCRIPTION OF THE PREFERRED EMBODIMENTS

Embodiments of the present invention will be described below with reference to the drawings.

### First Embodiment

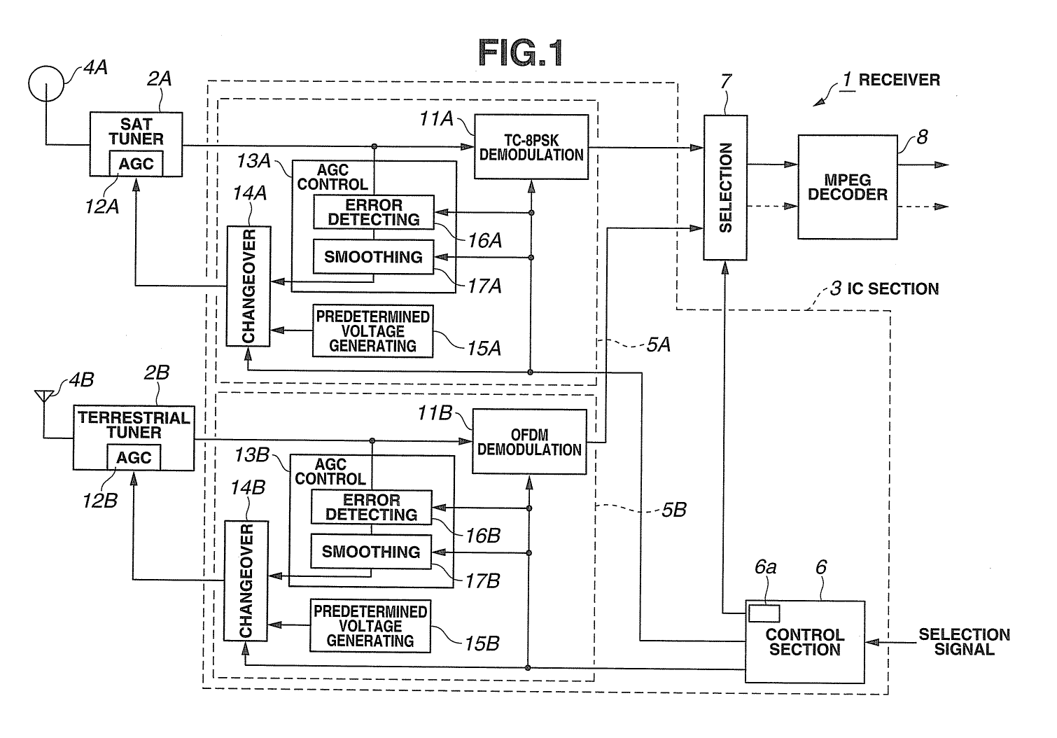

FIG. 1 illustrates a configuration of a receiver 1 according to a first embodiment of the present invention.

The receiver 1 includes a satellite digital tuner (abbreviated to “SAT tuner” below) 2A configured to receive satellite digital broadcasts from, for example, a broadcasting satellite or a communication satellite, a terrestrial digital tuner (abbreviated to “terrestrial tuner” below) 2B configured to receive terrestrial digital broadcasts from the ground, as a plurality of tuners, and a semiconductor integrated circuit section (abbreviated to “IC section” below) 3 as a demodulation section configured to demodulate an output signal from the both tuners 2A and 2B.

The SAT tuner 2A is connected to an SAT antenna 4A, and extracts a modulation signal having a desired frequency and digitally modulated by trellis-coded 8 phase shift keying (TC-8PSK) or the like from a radio wave received by the SAT antenna 4A.

Although the embodiment is described by using the TC-8PSK as a modulation scheme, the present invention is not limited to this modulation scheme, and for example, quadrature phase shift keying (QPSK) may be used.

The terrestrial tuner 2B is connected to a terrestrial antenna 4B, and extracts a modulation signal having a desired frequency and digitally modulated by, for example, orthogonal frequency division multiplexing (OFDM) from a radio wave received by the terrestrial antenna 4B.

Although the embodiment is described by using the OFDM as a modulation scheme, the present invention is not limited to this modulation scheme, and for example, a single-carrier scheme 8-vestigial sideband (8-VSB) may be employed.

The IC section 3 includes an SAT demodulation section 5A configured to perform digital demodulation on the digital modulation signal output from the SAT tuner 2A, a terrestrial demodulation section 5B configured to perform digital demodulation and error correction on the digital modulation signal output from the terrestrial tuner 2B, and a control section 6 configured to perform control thereof. The SAT demodulation section 5A, the terrestrial demodulation section 5B, and the control section 6 constituting the IC section 3 form a semiconductor integrated device formed by an IC.

Transport stream signals (abbreviated to “TS signal” below) which are demodulation signals respectively output from the SAT demodulation section 5A and the terrestrial demodulation section 5B pass through a selection switch 7 selected by the control section 6, and are input to, for example, an MPEG decoder 8 as a decoder configured to perform decoding on the TS signals compression-encoded by MPEG.

A selection signal which corresponds to selection to use/not to use the tuner by a user via, for example, a remote controller (abbreviated to “remote” below) is input to the control section 6. In accordance with the selection signal, the control section 6 controls selection of the selection switch 7 such that the output signal of the tuner which is used to receive a broadcast channel is selected.

For example, when a user selects one of the SAT demodulation section 5A and the terrestrial demodulation section 5B, one of the TS signals is selected and is input to the MPEG decoder 8 as shown by a solid line in FIG. 1 which is an output of the selection switch 7. The TS signal is decoded to an audio signal and a video signal by the MPEG decoder 8, and the audio signal, the video signal or the like are output.

The audio signal and the video signal are respectively signal-processed by an unshown audio signal processing section and an unshown video signal processing section at a post stage, and are respectively reproduced by a speaker and a display (a display panel).

When the user further selects to receive a broadcast channel by using the tuner which is not used for video and audio reproduction and to record contents or the like of the received broadcast channel on a hard disk device or the like, the demodulation signal of the tuner is input to the MPEG decoder 8 as shown by a dotted line in FIG. 1 which is an output of the selection switch 7.

An audio signal and a video signal used for recording are generated by the MPEG decoder 8. The audio signal and the video signal can be compression-encoded by MPEG by an unshown MPEG encoder to be recorded on the hard disk device or the like.

The SAT demodulation section 5A includes a TC-8PSK demodulation circuit 11A configured to perform digital demodulation, specifically, for example, TC-8PSI demodulation on the digital modulation signal output from the SAT tuner 2A.

The SAT demodulation section 5A also includes an AGC control circuit 13A configured to perform AGC control of an AGC amplifier (abbreviated simply to “AGC” in the drawing) 12A provided in the SAT tuner 2A, by the output signal from the SAT tuner 2A.

An AGC control signal generated by the AGC control circuit 13A is applied to an AGC control terminal configured to control an AGC gain of the AGC amplifier 12A via a changeover switch 14A.

The AGC control circuit 13A includes: an AGC error detecting circuit (abbreviated simply to “error detecting” in the drawing) 16A configured to detect an error between an input signal, which is the output signal from the SAT tuner 2A, and a standard amplitude value: and a smoothing circuit 17A configured to smooth an output signal of the AGC error detecting circuit 16A and output the output signal as the AGC control signal.

A predetermined voltage generating circuit 15A is also provided in the SAT demodulation section 5A, and a predetermined voltage generated by the predetermined voltage generating circuit 15A is applied to the AGC control terminal of the AGC amplifier 12A via the changeover switch 14A.

The predetermined voltage minimizes or sufficiently suppresses the AGC gain by the AGC amplifier 12A used in the SAT tuner 2A. Types of the SAT tuner 2A which is actually used include, a tuner in which the AGC gain increases when an AGC control voltage of the AGC amplifier 12A increases, and reversely, a tuner in which the AGC gain decreases when the AGC control voltage increases are used.

Therefore, in the present embodiment, there is provided the predetermined voltage generating circuit 15A configured to generate the predetermined voltage by which the AGC gain is sufficiently suppressed in accordance with characteristics of the AGC amplifier 12A mounted in the SAT tuner 2A.

As the AGC control circuit 13A configured to generate the AGC control signal, a circuit is employed capable of outputting the AGC control signal having such characteristics that the larger the amplitude of an input signal input to the AGC control circuit 13A corresponding to the characteristics of the AGC amplifier 12A, the more the gain of the AGC amplifier 12A is suppressed.

The control section 6 selectively controls changeover of the changeover switch 14A in accordance with the input selection signal. For example, when a user gives a selection instruction to perform reproduction or recording by using the SAT tuner 2A, the control section 6 controls the changeover of the changeover switch 14A such that the AGC control signal from the AGC control circuit 13A is applied to the AGC amplifier 12A.

On the other hand, when a user gives a selection instruction not to perform any of reproduction and recording by using the SAT tuner 2A, the control section 6 controls the changeover of the changeover switch 14A such that the predetermined voltage from the predetermined voltage generating circuit 15A is applied to the AGC amplifier 12A.

In this case, the control section 6 also stops or suppresses power supply to the TC-8PSK demodulation circuit 11A and the AGC control circuit 13A to reduce power consumption of the circuits when the circuits are not actually used. A normal AGC control loop is cut off in this case. However, since the control section 6 controls to apply the predetermined voltage to the AGC amplifier 12A as described above, the gain of the AGC amplifier 12A is in a sufficiently suppressed state.

The terrestrial demodulation section 5B has a similar configuration to the SAT demodulation section 5A as described below.

The terrestrial demodulation section 5B includes an OFDM demodulation circuit 11B configured to perform digital demodulation, specifically, for example, OFDM demodulation on the digital modulation signal output from the terrestrial tuner 2B.

The terrestrial demodulation section 5B also includes an AGC control circuit 13B configured to perform AGC control of an AGC amplifier 12B provided in the terrestrial tuner 2B by the output signal from the terrestrial tuner 2B. An AGC control signal generated by the AGC control circuit 13B is applied to an AGC control terminal of the AGC amplifier 12B via a changeover switch 14B.

A predetermined voltage generating circuit 15B is also provided in the terrestrial demodulation section 5B, and a predetermined voltage generated by the predetermined voltage generating circuit 15B is applied to the AGC control terminal of the AGC amplifier 12B via the changeover switch 14B.

The predetermined voltage minimizes or sufficiently suppresses the AGC gain by the AGC amplifier 12B used in the terrestrial tuner 2B. Types of the terrestrial tuner 2B which is actually used include, a tuner in which the AGC gain increases when an AGC control voltage of the AGC amplifier 12B increases, and reversely, a tuner in which the AGC gain decreases when the AGC control voltage increases.

Therefore, in the present embodiment, there is provided the predetermined voltage generating circuit 15B configured to generate the predetermined voltage by which the AGC gain is sufficiently suppressed in accordance with characteristics of the AGC amplifier 12B mounted in the terrestrial tuner 2B.

As the AGC control circuit 13B configured to generate the AGC control signal, a circuit is employed capable of outputting the AGC control signal having such characteristics that the larger the amplitude of an input signal input to the AGC control circuit 13B corresponding to the characteristics of the AGC amplifier 12B, the more the gain of the AGC amplifier 12B is suppressed.

The control section 6 selectively controls changeover of the changeover switch 14B in accordance with the input selection signal. For example, when a user gives a selection instruction to perform reproduction or recording by using the terrestrial tuner 2B, the control section 6 performs control such that the AGC control signal from the AGC control circuit 13B is applied to the AGC amplifier 12B.

On the other hand, when a user gives a selection instruction not to perform any of reproduction and recording by using the terrestrial tuner 2B, the control section 6 performs control such that the predetermined voltage from the predetermined voltage generating circuit 15B is applied to the AGC amplifier 12B.

In this case, the control section 6 also stops or suppresses power supply to the OFDM demodulation circuit 11B and the AGC control circuit 13B to reduce power consumption of the circuits which are not actually used.

As described above, when two different broadcasts are selected to be received at the same time, the receiver 1 according to the present embodiment performs receiving operations by respectively exercising AGC (control) functions by the AGC control signals generated based on the output signals from the respective tuners.

When it is selected to use only one of the tuners to receive a broadcast, the receiver 1 is configured to appropriately control the AGC functions so as not to give spurious interference or the like to the one tuner side by sufficiently suppressing the gain of the AGC amplifying means of the other tuner which is not used to receive a broadcast.

In a case where the two demodulation sections 5A and 5B are integratedly formed on the IC section 3, the respective demodulation sections can perform demodulation without influences from the spurious interference or the like. Therefore, miniaturization and cost reduction of the IC section 3 and the receiver 1 including the IC section 3 can be achieved.

Selection information of the both tuners 2A and 2B is stored in a storage section 6a of the control section 6, for example, just before the receiver 1 is turned OFF. When the receiver 1 is turned ON, the control section 6 performs initial setting based on the information stored in the storage section 6a.

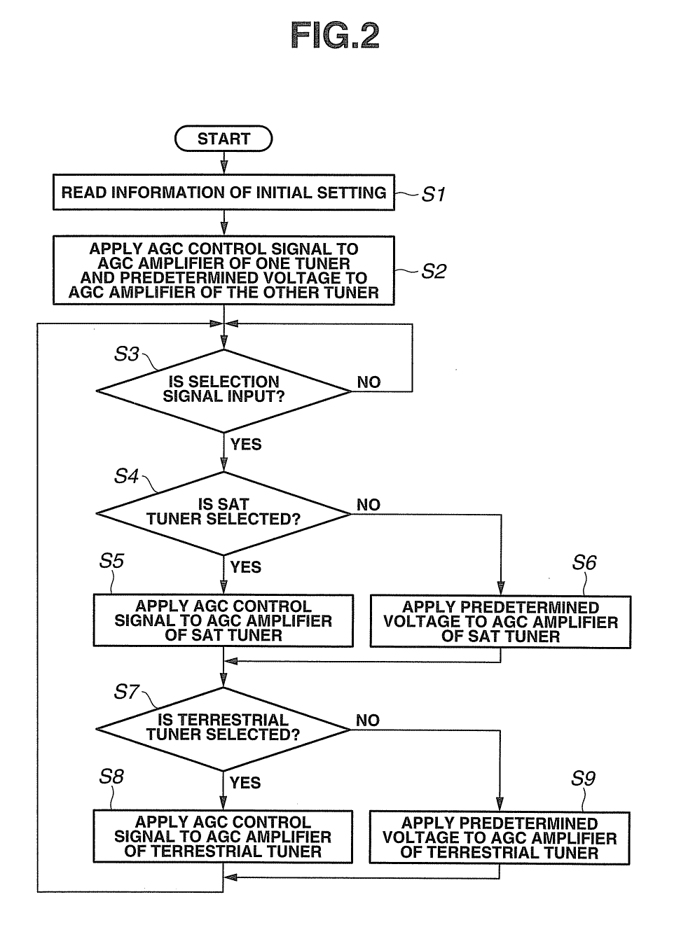

Next, operations of the present embodiment will be described. FIG. 2 illustrates a flowchart of a representative operation content example of the present embodiment.

When the receiver 1 is turned ON and is set to an operation state, the control section 6 reads, for example, the information of the storage section 6a in the control section 6 to perform the initial setting at the activation time as shown in a step S1.

As the initial setting based on the information, for example, a selected usage state in which one of the tuners is selected is set.

Specifically, for example, information of the tuner used for reproduction (reception) at the time of previous power OFF is stored in the storage section 6a. When the receiver 1 is turned ON next time, this tuner is tentatively set to be selected for reproduction. Alternatively, a user can store information of the tuner to be selected at the time of activation in the storage section 6a in advance, so that this tuner is selected at the time of activation.

In the following description, reference numeral 2I denotes the tuner to be selected at the time of activation, and reference numeral 2J denotes the other tuner. That is, I is A or B, and for example, when I is A, J is B. When I is B, J is A.

In this case, as shown in a step S2, the control section 6 controls changeover of a changeover switch 14I such that the AGC control signal is applied to an AGC amplifier 12I of the selected tuner 2I. The control section 6 also controls changeover of a changeover switch 14J such that the predetermined voltage is applied to an AGC amplifier 12J of the tuner 2J which is not selected.

In a next step S3, the control section 6 awaits an input of the selection signal. When a user wants to reproduce a broadcast in a previous usage state, the broadcast can be received (reproduced) in the desired setting state immediately at the time of activation.

On the other hand, when the user wants to use the tuner 2J different from the selected tuner 2I for reproduction, or to use the other tuner 2J for recording (use the both tuners), the user performs an instruction operation by the remote or the like. The selection signal is thereby input to the control section 6.

When the selection signal is input, the control section 6 determines whether the selection signal is to select, for example, the SAT tuner 2A as shown in a step S4.

When it is determined that the selection signal is to select the SAT tuner 2A, the control section 6 controls the changeover of the changeover switch 14A such that the AGC control signal is applied to the AGC amplifier 12A of the selected SAT tuner 2A as shown in a step S5.

On the other hand, when it is determined in the step S4 that the selection signal is not to select the SAT tuner 2A, the control section 6 controls the changeover of the changeover switch 14A such that the predetermined voltage is applied to the AGC amplifier 12A of the SAT tuner 2A as shown in a step S6.

After the process in the step S5 or S6, the process moves to a step S7. In the step S7, the control section 6 determines whether the selection signal in the step S3 is to select the terrestrial tuner 2B.

When it is determined that the selection signal is to select the terrestrial tuner 2B, the control section 6 controls the changeover of the changeover switch 14B such that the AGC control signal is applied to the AGC amplifier 12B of the selected terrestrial tuner 2B as shown in a step S8.

On the other hand, when it is determined in the step S7 that the selection signal is not to select the terrestrial tuner 2B, the control section 6 controls the changeover of the changeover switch 14B such that the predetermined voltage is applied to the AGC amplifier 12B of the terrestrial tuner 2B as shown in a step S9.

After the process in the step S8 or S9, the process in FIG. 2 is terminated or returns to the step S3.

According to the present embodiment operating as described above, the plurality of tuners 2A and 2B can be used at the same time in the IC section 3 on which the different demodulation sections 5A and 5B are integrated so as to perform demodulation processes in the case where the plurality of tuners 2A and 2B are provided.

Also, according to the present embodiment, when only one of the tuners is used, it is possible to effectively prevent the tuner side which is not used from giving spurious interference and noise interference to the tuner side which is used.

Although the case of using the SAT tuner 2A and the terrestrial tuner (terrestrial digital tuner) 2B as the example of the plurality of tuners is described in the first embodiment, the present invention is not limited to the above case. For example, a terrestrial analog tuner may be employed as the terrestrial tuner. The terrestrial analog tuner may be also employed instead of the SAT tuner.

Although the case of using the two tuners is described in the configuration of FIG. 1, the present invention may be also applied to a case of using three tuners by further adding the terrestrial analog tuner.

Next, a receiver having a function of monitoring irregular broadcasts such as emergency warning broadcasts in a non-selected state (sleep operation mode) in one tuner will be described.

### Second Embodiment

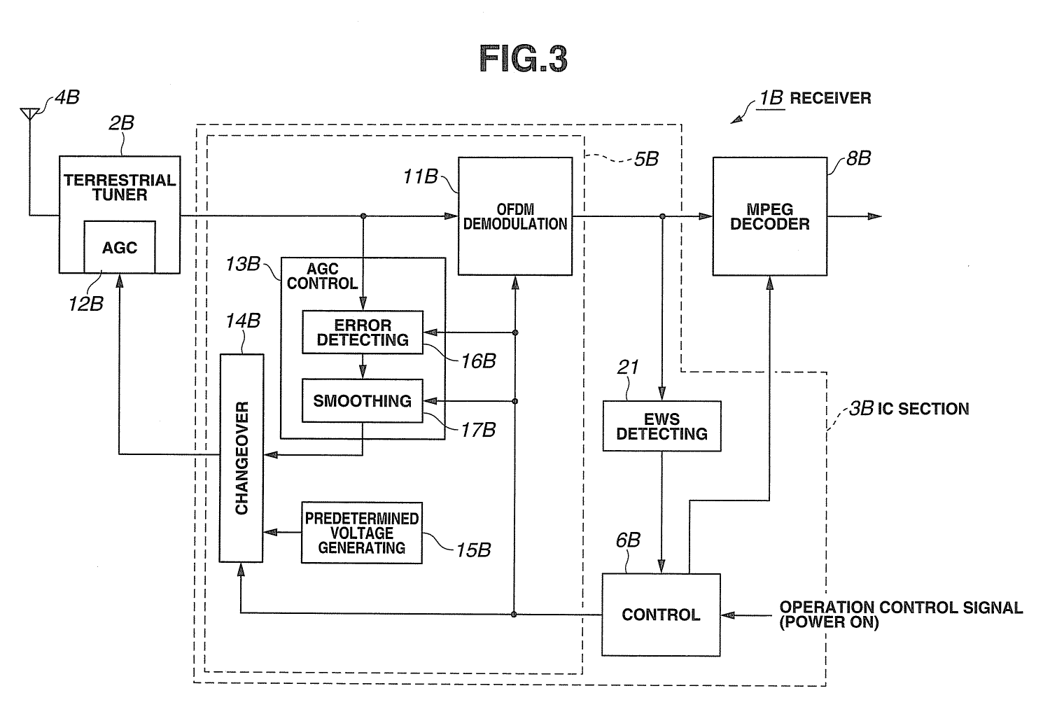

FIG. 3 illustrates a configuration of a receiver 1B according to a second embodiment of the present invention.

The receiver 1B has a similar configuration, for example, to the terrestrial tuner 2B side in FIG. 1. Therefore, the same components as the components shown in FIG. 1 are assigned the same reference numerals, omitting descriptions thereof. The present embodiment may be similarly applied to a case where the SAT tuner 2A is used. The present embodiment may be also applied to one of or both of the tuners in FIG. 1.

The receiver 1B includes one IC section 3B and one MPEG decoder 8B as in the first embodiment. The IC section 3B includes a terrestrial demodulation section 5B as one digital demodulation section, a control section 6B configured to perform control, and an EWS detecting section 21 described below.

In the receiver 1B, an output signal of an OFDM demodulation circuit 11B is output to the MPEG decoder 8B, and also passes through the EWS detecting section 21 configured to detect presence of an emergency warning signal (abbreviated to “EWS” below) as an irregular broadcast signal which is broadcast irregularly, to be input to the control section 6B. The MPEG decoder 8B performs MPEG decoding on the output signal from the OFDM demodulation circuit 11B as one demodulation section, and outputs a video signal and an audio signal.

In the present embodiment, when the receiver 1B is turned ON, an operation control signal is input to the control section 6B such that an operation of receiving terrestrial digital broadcasts (normal operation mode) is performed by the receiver 1B.

When the operation control signal is input, the control section 6B performs control such that an AGC control signal is applied to an AGC amplifier 12B of the terrestrial tuner 2B as in the case where the selection signal configured to select the tuner is input in the first embodiment.

On the other hand, when the operation control signal is not input, that is, when the receiver 1B is turned OFF, the control section 6B controls the sleep operation mode which responds to reception of the EWS.

In the sleep operation mode, the control section 6B does not completely turn OFF a broadcast receiving function of the receiver 1B, but brings the receiver 1B into a state of performing an operation of periodically detecting the EWS by emergency warning broadcasts.

More specifically, in the sleep operation mode, the control section 6B sets the receiver 1B to a first mode (also referred to as “receiving mode”) in which the EWS is periodically detected equivalent to the normal operation mode, and a second mode (also referred to as “sleep mode”) in which the receiving function is practically stopped.

The control section 6B applies the AGC control signal to the AGC amplifier 12B of the terrestrial tuner 2B during the receiving mode as the first mode. The presence of the EWS is detected during an operation of the first mode.

The EWS detecting section 21 detects the EWS by presence of an emergency warning broadcast flag in transmission and multiplexing configuration control (TMCC) information decoded by an unshown TMCC decoder in the OFDM demodulation circuit 11B (the emergency warning broadcast flag is set to ON at the time of emergency warning broadcast).

When the EWS detecting section 21 detects the emergency warning broadcast flag, the EWS detecting section 21 notifies the control section 6B that the EWS has been detected.

On the other hand, the control section 6B applies a predetermined voltage to the AGC amplifier 12B of the terrestrial tuner 2B during the sleep mode as the second mode. That is, the control section 6B brings the receiver 1B into a low power consumption state, and also controls gain suppression of the AGC amplifier 12B such that spurious interference or the like is not given to surroundings. In this case, the control section 6B also sets the OFDM demodulation circuit 11B or the like to a non-operation state, for example, to a low power consumption state in which power supply to the OFDM demodulation circuit 11B is stopped.

In the sleep operation mode, with respect to the MPEG decoder 8B and subsequent processing blocks, the control section 6B controls, for example, to stop or reduce power to the MPEG decoder 8B and stop or reduce power supply to a TS decoder, a video signal processing section, an audio signal processing section or the like. This is the point where the sleep operation mode differs from when the receiver 1B is normally turned ON.

When a signal indicating that the EWS has been detected is input to the control section 6B by the EWS detecting section 21 in the first mode of the sleep operation mode, the control section 6B controls to perform an operation of reproducing an emergency warning broadcast corresponding to the EWS.

The present embodiment has such an advantage that the EWS can be detected with low power consumption by, for example, periodically detecting the EWS in the sleep operation mode.

The cycle in which the first mode and the second mode are alternately performed in the sleep operation mode has only to be set to a cycle by which the operation of detecting the emergency warning broadcast flag from the TMCC information described above can be stably performed.

For example, in a case where the emergency warning broadcast flag can be detected for a few times to about ten times when the receiver 1B constantly operates in the first mode, the cycle has only to be set to a cycle by which the emergency warning broadcast flag can be detected a few times smaller than the above number of times. By setting as described above, power consumption can be dramatically reduced in comparison with the case where the receiver 1B constantly operates in the first mode.

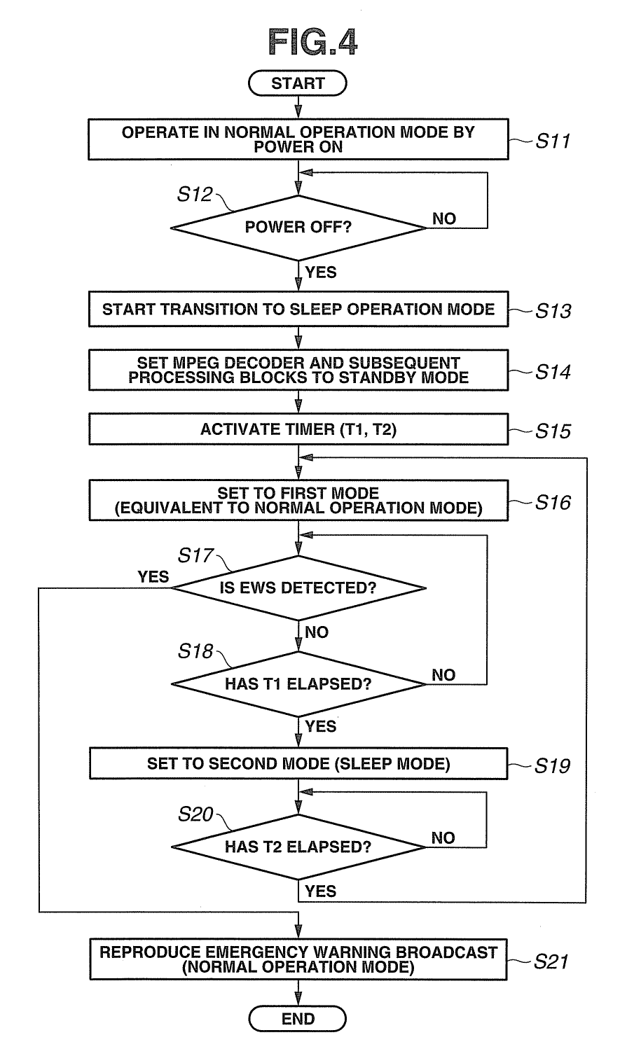

Next, operations of the present embodiment will be described with reference to a flowchart in FIG. 4.

For example, in a first step S11, the receiver 1B is set to a power ON state and the receiver 1B performs the operation of receiving terrestrial digital broadcasts in the normal operation mode in this state.

In a next step S12, the control section 6B is brought into a waiting state for an operation that the receiver 1B is turned OFF.

When the receiver 1B is turned OFF, the control section 6B starts transition of the receiver 1B to the sleep operation mode as shown in a step S13.

When the transition to the sleep operation mode is started, the control section 6B sets the MPEG decoder 8B and the subsequent circuit blocks to a power OFF state or a low power consumption state such as a standby mode as shown in a step S14.

At almost the same time as the step S14, the control section 6B activates a timer which is not shown in a step S15. The timer sequentially measures a time period of the first mode (referred to as T1) and a time period of the second mode (referred to as T2). The timer notifies the control section 6B of the measurement results.

When the timer is activated in the step S15, the control section 6B also sets (controls) the receiver 1B, for example, to operate in the first mode as shown in a step S16.

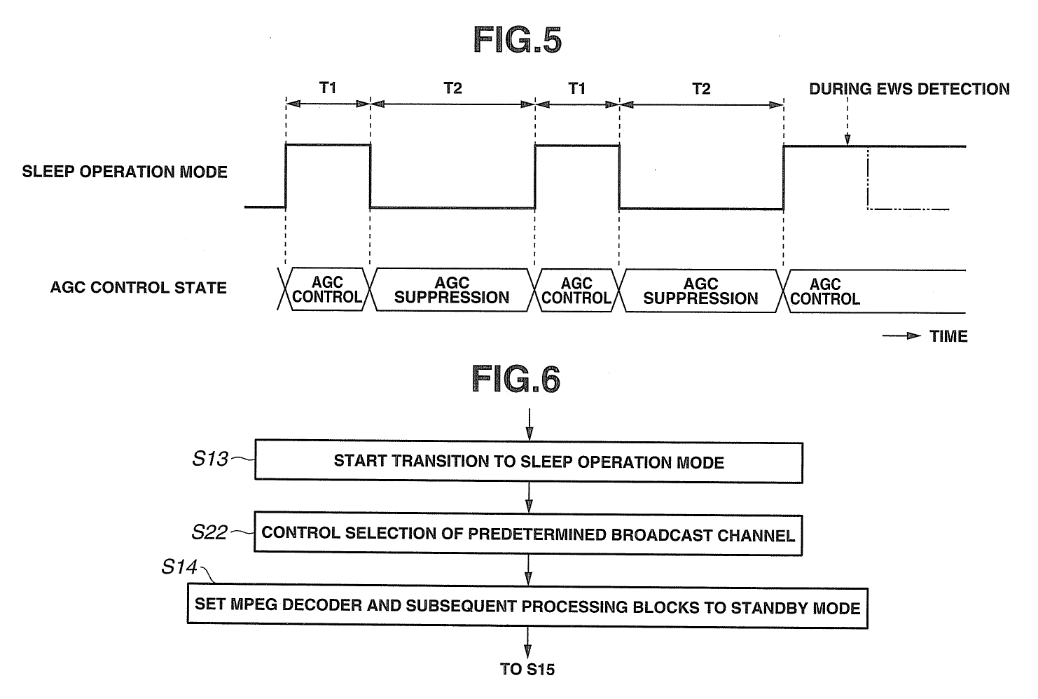

In this state, the AGC control signal is applied to the AGC amplifier 12B of the terrestrial tuner 2B as in the normal operation mode in the step S11. The operation state is shown in FIG. 5.

FIG. 5 illustrates an AGC control state of the AGC amplifier 12B in the first mode and the second mode during the respective time periods T1 and T2 in the sleep operation mode. In the first mode, AGC control is performed by the AGC control signal.

The control section 6B determines whether the EWS has been detected by the signal from the EWS detecting section 21 as shown in a step S17. When the EWS has not been detected, the control section 6B determines whether the time period T1 has elapsed in a next step S18. When the time period T1 has not elapsed, the process returns to the step S17.

On the other hand, when the time period T1 has elapsed, the control section 6B sets the receiver 1B to the second mode (sleep mode) in a step S19.

In the sleep mode, the control section 6B controls to apply the predetermined voltage to the AGC amplifier 12B of the terrestrial tuner 2B. This state is shown in FIG. 5. In the second mode, AGC suppression control for suppressing the gain of the AGC amplifier 12B by the predetermined voltage is performed.

The control section 6B also sets the OFDM demodulation section 5B or the like to the low power consumption mode such as the standby mode.

In a next step S20, the control section 6B waits for elapse of the time period T2. When the time period T2 has elapsed, the process returns to the step S16 and the same operations are repeated.

On the other hand, when the EWS is detected in the step S17, the process moves to a step S21. In the step S21, the control section 6B controls to set the receiver 1B to a state of receiving the emergency warning broadcast.

In the example of FIG. 5, in the EWS detection, the receiver 1B maintains a state in which the receiver 1B operates by the AGC control signal after the EWS is detected (when the EWS is not detected, periodic operations are performed like an alternate long and short dashes line).

When the EWS is detected, the control section 6B sets the MPEG decoder 8B or the like, which was set to the standby mode state, to the operation mode state, so as to perform video and audio reproduction of the emergency warning broadcast.

After performing such operations, the process operations in FIG. 4 are terminated.

According to the present embodiment in which such operations are performed, even when the receiver 1B is set to a power OFF state, the receiver 1B can receive an emergency warning broadcast when there is an emergency warning broadcast. In this case, since monitoring of the EWS is not constantly performed but is periodically performed, power consumption can be dramatically reduced in comparison with the case where the EWS is constantly monitored.

In the case where the EWS is periodically monitored, power consumption can be more dramatically reduced by setting the time period T1 to be smaller (shorter) than the time period T2 as shown in FIG. 5.

Moreover, in the present embodiment, since the voltage applied to the AGC amplifier 12B in the second operation mode is set to be able to sufficiently decrease the AGC gain, the influences of spurious interference and noise given to surroundings can be reduced.

A modified example as described below of the present embodiment may be also employed. For example, in the process operations shown in FIG. 4, the EWS may be detected by setting the receiver 1B to a state of selecting a broadcast frequency of a broadcast (for example, public broadcast) from a predetermined broadcast station well organized to perform emergency warning broadcasts during the sleep operation mode.

Specifically, in the case of the process operations of FIG. 4, when the receiver 1B is turned OFF and the transition to the sleep operation mode is started as shown in the step S13, the control section 6B controls selection such that a predetermined broadcast channel is set to a received channel as shown in a step S22 in FIG. 6.

After the step S22, the process of the step S14 may be performed. According to the present modified example, emergency warning broadcasts can be more surely received. The modified example has similar effects to the second embodiment in other points.

The second embodiment may be also applied to the first embodiment having the plurality of tuners. In this case, when the receiver 1 is turned OFF, the operations in the second embodiment may be performed in one of the two tuners. The other tuner side may be completely turned OFF or may be set to a state close to the power OFF state.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A receiver comprising:
a first tuner configured to select a broadcast channel;
a first AGC control circuit configured to generate a first AGC control signal configured to control a gain of a first AGC amplifier provided in the first tuner, based on an output signal from the first tuner;
a first predetermined voltage generating circuit configured to generate a first predetermined voltage configured to suppress an AGC gain of the first AGC amplifier;
a second tuner configured to select a broadcast channel different from that of the first tuner;
a second AGC control circuit configured to generate a second AGC control signal configured to control a gain of a second AGC amplifier provided in the second tuner, based on an output signal from the second tuner;
a second predetermined voltage generating circuit configured to generate a second predetermined voltage configured to suppress an AGC gain of the second AGC amplifier; and
a control section configured to control to selectively apply the first AGC control signal and the first predetermined voltage to the first AGC amplifier, and
configured to control to selectively apply the second AGC control signal and the second predetermined voltage to the second AGC amplifier.

2. The receiver according to claim 1, wherein
when the first tuner and the second tuner are respectively used to select broadcast channels, the control section controls to apply the first AGC control signal and the second AGC control signal respectively to the first AGC amplifier and the second AGC amplifier, and
when one of the first tuner and the second tuner is not used to select a broadcast channel, the control section controls to apply, to one of the AGC amplifiers provided in the one of the tuners, the predetermined voltage configured to sufficiently suppress the AGC gain of the one of the AGC amplifiers.

3. The receiver according to claim 1, wherein
at least one of the first tuner and the second tuner is a digital tuner configured to receive a digital broadcast, and the receiver further comprises a digital demodulation section configured to perform digital demodulation on a digital modulation signal from the digital tuner.

4. The receiver according to claim 2, wherein
at least one of the first tuner and the second tuner is a digital tuner configured to receive a digital broadcast, and the receiver further comprises a digital demodulation section configured to perform digital demodulation on a digital modulation signal from the digital tuner.

5. The receiver according to claim 3, wherein
the digital tuner comprises a tuner configured to receive a terrestrial digital broadcast.

6. The receiver according to claim 3, wherein
the digital tuner comprises a tuner configured to receive a satellite digital broadcast.

7. The receiver according to claim 1, wherein
when the receiver is turned OFF, the control section controls to periodically apply, to one of the AGC amplifiers provided in one of the first tuner and the second tuner, the predetermined voltage configured to sufficiently suppress the AGC gain of the one of the AGC amplifiers and the AGC control signal generated from the output signal of the one of the tuners.

8. The receiver according to claim 2, wherein
when the receiver is turned OFF, the control section controls to periodically apply, to one of the AGC amplifiers provided in one of the first tuner and the second tuner, the predetermined voltage configured to sufficiently suppress the AGC gain of the one of the AGC amplifiers and the AGC control signal generated from the output signal of the one of the tuners.

9. The receiver according to claim 3, wherein
when the receiver is turned OFF, the control section controls to periodically apply, to one of the AGC amplifiers provided in one of the first tuner and the second tuner, the predetermined voltage configured to sufficiently suppress the AGC gain of the one of the AGC amplifiers and the AGC control signal generated from the output signal of the one of the tuners.

10. The receiver according to claim 1, wherein
the first AGC control circuit comprises a first error detecting circuit configured to detect an error between an amplitude value of the output signal of the first tuner and a first standard amplitude value, and a first smoothing circuit configured to smooth an output signal of the first error detecting circuit and output the output signal as the first AGC control signal, and
the second AGC control circuit comprises a second error detecting circuit configured to detect an error between an amplitude value of the output signal of the second tuner and a second standard amplitude value, and a second smoothing circuit configured to smooth an output signal of the second error detecting circuit and output the output signal as the second AGC control signal.

11. The receiver according to claim 1, wherein
the control section controls to partly reduce power consumption of a tuner of the first tuner and the second tuner that is not used to select a broadcast channel.

12. The receiver according to claim 1, wherein
the control section controls to reduce power consumption of the AGC control circuit of a tuner of the first tuner and the second tuner that is not used to select a broadcast channel.

13. The receiver according to claim 1, wherein
the control section controls to reduce power consumption of a demodulation section configured to demodulate a modulation signal, of a tuner of the first tuner and the second tuner that is not used to select a broadcast channel.

14. The receiver according to claim 1, wherein
when the receiver is turned ON, the control section controls to selectively use one of the first tuner and the second tuner based on information stored in a storage section.

15. The receiver according to claim 1, further comprising:
a broadcast signal detecting section configured to detect presence of a broadcast signal that is broadcast irregularly, by using the output signal of at least one of the first tuner and the second tuner.

16. The receiver according to claim 1, wherein
when the receiver is turned OFF, the control section controls to periodically detect presence of a broadcast signal that is broadcast irregularly from the output signal of at least one of the first tuner and the second tuner.

17. A semiconductor integrated device comprising:
a first AGC control circuit configured to generate a first AGC control signal configured to control a gain of a first AGC amplifier provided in a first tuner configured to select a broadcast channel, based on a first tuner output signal from the first tuner;
a first predetermined voltage generating circuit configured to generate a first predetermined voltage configured to suppress an AGC gain of the first AGC amplifier;
a second AGC control circuit configured to generate a second AGC control signal configured to control a gain of a second AGC amplifier provided in a second tuner configured to select a broadcast channel different from that of the first tuner based on a second tuner output signal from the second tuner;
a second predetermined voltage generating circuit configured to generate a second predetermined voltage configured to suppress an AGC gain of the second AGC amplifier; and
a control section configured to control to selectively apply the first AGC control signal and the first predetermined voltage to the first AGC amplifier, and
configured to control to selectively apply the second AGC control signal and the second predetermined voltage to the second AGC amplifier,
the first AGC control circuit, the first predetermined voltage generating circuit, the second AGC control circuit, the second predetermined voltage generating circuit, and the control section being formed on a semiconductor integrated circuit.

18. The semiconductor integrated device according to claim 17, wherein
when the first tuner and the second tuner are respectively used to select broadcast channels, the control section controls to apply the first AGC control signal and the second AGC control signal respectively to the first AGC amplifier and the second AGC amplifier, and
when one of the first tuner and the second tuner is not used to select a broadcast channel, the control section controls to apply, to one of the AGC amplifiers provided in the one of the tuners, the predetermined voltage configured to sufficiently suppress the AGC gain of the one of the AGC amplifiers.

19. The semiconductor integrated device according to claim 17, wherein
at least one of the first tuner and the second tuner is a digital tuner configured to receive a digital broadcast, and the semiconductor integrated device further comprises a digital demodulation section configured to perform digital demodulation on a digital modulation signal from the digital tuner.

20. The semiconductor integrated device according to claim 17, wherein
when the receiver is turned OFF, the control section controls to periodically apply, to one of the AGC amplifiers provided in one of the first tuner and the second tuner, the predetermined voltage configured to sufficiently suppress the AGC gain of the one of the AGC amplifiers and the AGC control signal generated from the output signal of the one of the tuners.
